(19) United States
(12) Patent Application Publication
(10) Pub. No.: US 2014/0078288 A1
(43) Pub. Date: Mar. 20, 2014

(54) Far Field In Situ Maximum Horizontal Stress Direction Estimation Using Multi-Axial Induction And Borehole Image Data

(71) Applicant: Schlumberger Technology Corporation, (US)

(72) Inventor: Peter T. Wu, Missouri City, TX (US)

(73) Assignee: SCHLUMBERGER TECHNOLOGY CORPORATION, Sugar Land, TX (US)

(21) Appl. No.: 13/784,033

(22) Filed: Mar. 4, 2013

Related U.S. Application Data
(60) Provisional application No. 61/661,403, filed on Jun. 19, 2012.

(51) Int. Cl. G01V 3/38; H04N 7/18

(52) U.S. Cl. CPC G01V 3/38; H04N 7/183
USPC 348/85

(57) ABSTRACT

A method for determining far field maximum stress direction of formations penetrated by a wellbore from multiaxial electromagnetic induction measurements and formation image measurements made in the wellbore includes determining whether fractures exist in a far field from the wellbore using the multiaxial electromagnetic induction measurements. The fractures are determined to be naturally occurring or induced using the formation image measurements. Orientation of the fractures when determined to be induced are determined. The far field maximum stress direction is then determined based upon the determined orientation.

### CROSS-REFERENCE TO RELATED APPLICATION

This application claims the benefit of a related U.S. Provisional Patent Application Ser. No. 61/661,403, filed Jun. 19, 2012, entitled “FAR FIELD IN SITU MAXIMUM HORIZONTAL STRESS DIRECTION ESTIMATION USING TRIAXIAL INDUCTION AND BOREHOLE IMAGE DATA,” the disclosure of which is incorporated by reference herein in its entirely.

### BACKGROUND

This disclosure relates generally to the field of subsurface formation fracture evaluation. More specifically, the disclosure relates to techniques for evaluating far-field maximum horizontal stress direction using measurements from multiaxial electromagnetic induction well logging instruments and wellbore imaging devices.

A tri-axial induction well logging instrument such as one sold under the trademark RT SCANNER, which is a trademark of Schlumberger Technology Corporation, Sugar Land, Tex., measures 9-component apparent conductivity tensors (σm(i, j, k), i, j=x, y, z) at multiple electromagnetic induction receiver spacings from an electromagnetic induction transmitter, wherein each spacing is represented by the index k. FIG. 2 schematically illustrates such a tri-axial instrument including a transmitter T, an individual receiver (consisting of a main receiver R and a balancing or “bucking” receiver Rb) and the corresponding measurement tensor C (which consists of voltages induced in each of the three individual directional receiver components as induced by each of the three individual transmitter directional components). These measurements are usually obtained in frequency domain by operating the transmitter T with a continuous wave (CW) having one or more selected, discrete frequencies to enhance the signal-to-noise ratio. However, measurements of the same information content could also be obtained and used from time domain signals (e.g., generated by passing a transient current through the transmitter T) using a Fourier decomposition process. This is a well-known physics principle of frequency-time duality. Formation properties, such as horizontal and vertical conductivities (σh, σv), relative dip angle (θ) and the dip azimuthal direction (Φ) of subsurface formations, as well as borehole/tool properties, such as mud conductivity (σmud), wellbore diameter (hd), tool eccentering distance (decc), tool eccentering azimuthal angle (ψ), all affect the components of the conductivity tensor C.

FIG. 3 illustrates an eccentered tool in a borehole through an anisotropic formation with a dip angle. Using a simplified model having a layered anisotropic formation traversed obliquely by a wellbore, the response of the conductivity tensor (C in FIG. 2) depends on the above eight parameters in a complicated manner. The effects of the wellbore and tool orientation and position on the measured conductivity tensor may be large even in an oil based mud (OBM) environment (i.e., wherein the borehole conductivity is low or close to zero). Through an inversion technique, the above wellbore and formation parameters can be calculated and the borehole effects can be removed from the measured conductivity tensors.

The formation parameters (vertical and horizontal conductivities, dip and dip azimuth) are usually calculated and displayed substantially in real-time (i.e., as the tool is moved along the wellbore) to help make various decisions related to the drilling and completion of the wellbore. The resistivities (the inverse of conductivities) of the rock formation are widely used, for example, to delineate low resistivity laminated hydrocarbon bearing formations. The dip and dip azimuth are used to map the structure of the formations on a scale much finer than that provided by, for instance, surface reflection seismic measurements. One of the important items of information that would affect the drilling and completion decisions of the well is whether the well has traversed significant fracture zones. Fractures occur frequently in certain formations due to the tectonic force over past geological time. Fractures could also be induced by the drilling operation. Large, deep (“deep” in the present context meaning at a substantial lateral distance from the wellbore) fracture systems can sometime be a principal factor related to commercially useful production of oil and gas from the particular formation. Large, deep fracture systems traversed by the wellbore could also cause loss of drilling mud. Knowing the locations of the fracture zones and the fracture plane orientations can significantly improve drilling and completion decisions.

Very thin fractures with large planar extent filled with OBM may block the induced current in the formation caused by the transmitter of an induction well logging instrument and could produce significant anomalies in the inverted formation parameters compared with those from the same formation without fractures. The size of the anomalies depends on the formation resistivities (Rh, Rv), the size of the fracture plane, and the relative dip and azimuth between the fracture plane and the layering structure of the formation. If the fracture plane is nearly perpendicular to the tool axis, the effects of the fracture on the tri-axial electromagnetic induction measurement may be small. On the other hand, if the fracture plane is nearly parallel to the tool axis the effect of the fracture may dominate the response of the tri-axial induction well logging instrument. The most common fracture system traversed by a typical wellbore is disposed in substantially horizontal layered formations, wherein the fractures are substantially vertical.

Technique for determining the far field (distant from the wellbore) in situ maximum horizontal stress direction may be beneficial in this regard. Uses for the in situ far field maximum horizontal stress direction are given as non limiting examples: geomechanics for predicting borehole integrity, hydraulic fracture design, and placement of a next wellbore or wellbores for optimized reservoir production.

For example, such a method could be applied to efficient shale gas production techniques. Shale gas production depends to a substantial extent on hydraulic fracturing. It is not trivial to determine a priori or during drilling of the well path of a shale gas production well which provides efficient connection to a hydraulic fracture system in the formation. Accordingly, the in situ far field maximum horizontal stress direction may be useful in predicting which direction induced hydraulic fractures will propagate.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

One aspect of the disclosure relates to a method for determining far field maximum stress direction of formations penetrated by a wellbore from multiaxial electromagnetic induction measurements and formation image measurements made in the wellbore. A method according to this aspect includes determining whether fractures exist in a far field from the wellbore using the multiaxial electromagnetic induction measurements. The fractures are determined to be naturally occurring or induced using the formation image measurements. Orientation of the fractures is determined when the fractures are determined to be induced. The far field maximum stress direction is determined from the determined induced fracture orientation.

### BRIEF DESCRIPTION OF THE DRAWINGS

Certain embodiments are described below with reference to the following figures:

FIG. 1A shows an example multiaxial electromagnetic well logging instrument disposed in a wellbore drilled through subsurface formations.

FIG. 1B shows an example wellbore imaging instrument disposed in a wellbore drilled through subsurface formations.

FIG. 2 shows an illustration of a multiaxial (e.g., triaxial) induction array measurement devices (i.e., transmitter and receivers) at a given spacing between the transmitter and each receiver.

FIG. 3 shows schematically an eccentered multiaxial induction tool in a wellbore passing through an anisotropic formation at a relative dip angle.

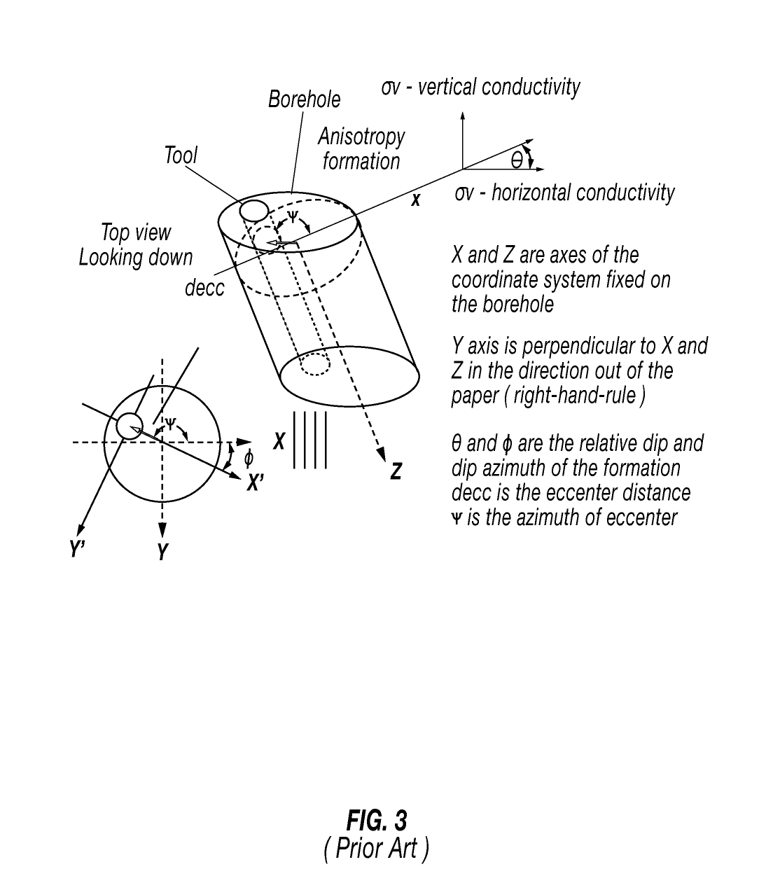

FIG. 4 shows schematically a wellbore top view showing the direction of maximum and minimum horizontal stress direction.

FIG. 5 shows a core picture of induced petal, centerline, and petal-centerline fractures.

FIG. 6 shows an image of a pattern of induced fractures formed ahead and behind the bit (see FIG. 1B).

FIG. 7 shows an example image of a wellbore containing both natural fractures and induced fractures.

FIG. 8 schematically shows the difference between the near field and far field maximum stress direction.

FIG. 9 schematically shows a multi-axial induction well logging instrument detecting only the far field maximum stress direction.

FIG. 10 shows a flowchart for determining the far field maximum horizontal stress direction from the multiaxial and wellbore image instrument measurements.

FIG. 11 shows an example computer system adapted to perform one or more of the methods discussed below.

### DETAILED DESCRIPTION

The present description is made with reference to the accompanying drawings, in which example embodiments are shown. However, many different embodiments may be used, and thus the description should not be construed as being limited to the embodiments set forth herein. Rather, these embodiments are provided so that this disclosure will be thorough and complete. Generally, like numbers refer to like elements throughout the present description.

In accordance with embodiments of the present disclosure, a far field maximum stress direction map can obtained, for example, from well logging data obtained from a grid of pilot wells covering a shale gas reservoir area. Based on such a map, efficient production well paths can be designed to be perpendicular to the far field maximum horizontal stress direction to obtain an optimum induced fracture drainage system. Example techniques to obtain such a map will now be explained in more detail.

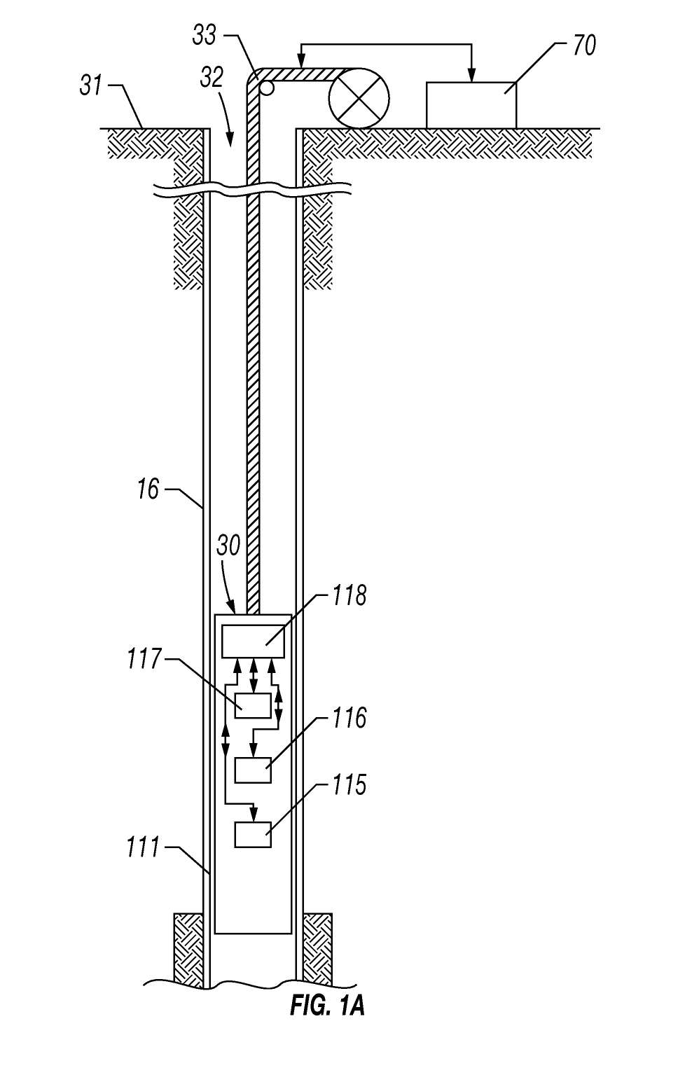

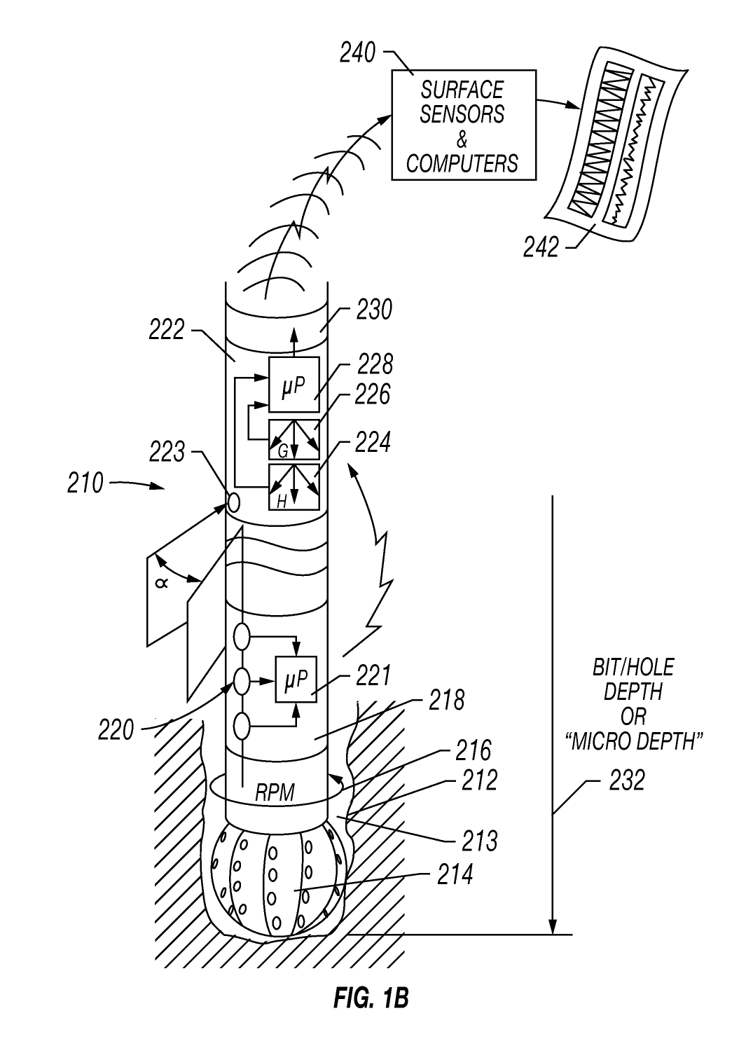

FIG. 1A shows an example multiaxial electromagnetic well logging instrument 30. The measurement components of the multiaxial electromagnetic well logging instrument 30 may be disposed in a housing 111 shaped and sealed to be moved along the interior of a wellbore. By way of example only, the well logging instrument 30 may be of a type sold under the name RT SCANNER™, which is a trademark of Schlumberger Technology Corporation, Sugar Land, Tex.

The instrument housing 111 may contain a multiaxial transmitter 115, and two or more multiaxial receivers 116, 117 each disposed at a different axial spacing from the multiaxial transmitter 115. The multiaxial transmitter 115, when activated, may emit a continuous wave electromagnetic field at one or more selected frequencies along a plurality of selected electromagnetic dipole directions. Shielding (not shown) may be interposed between the transmitter 115 and the axially closest receiver (e.g., 116) to reduce the effects of direct electromagnetic communication between the transmitter 115 and the receivers 116, 117. The multiaxial receivers 116, 117 may be multi-axis wire coils each coupled to a respective receiver circuit (not shown separately). Thus, detected electromagnetic energy may be characterized at each of a plurality of distances from the transmitter 115 along each of a plurality of selected magnetic dipole directions.

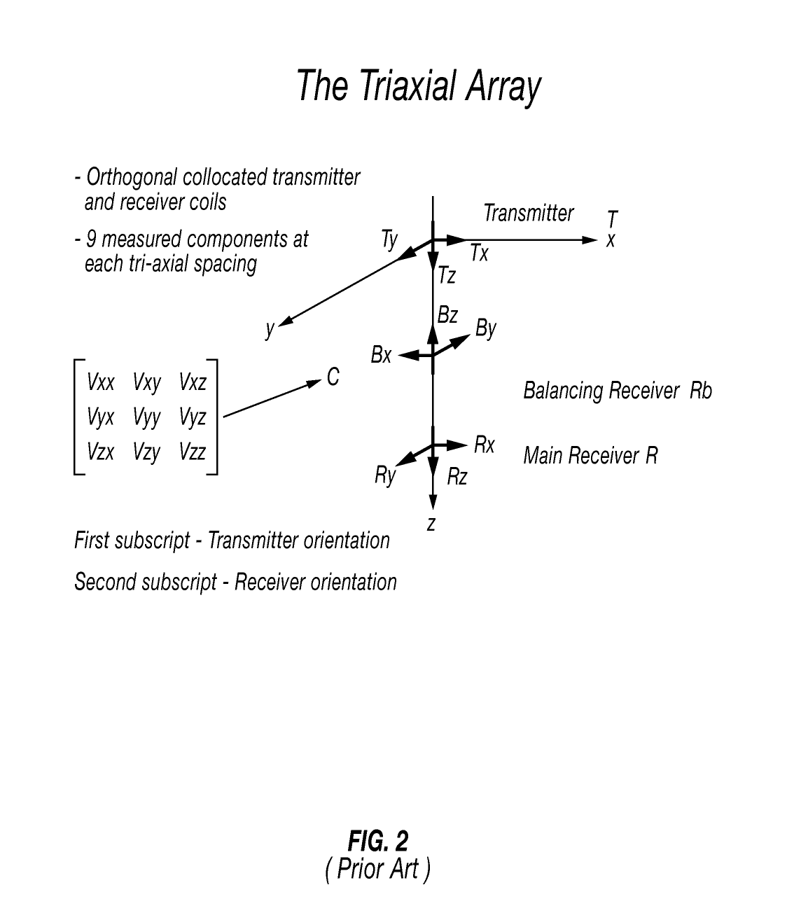

The transmitter 115 and receivers 116, 117 may be triaxial, as explained with reference to FIG. 2, wherein an axis of one of the magnetic dipoles of one of the collocated antennas may be oriented along the longitudinal axis of the instrument, and two other dipole moment axes may be mutually orthogonally oriented to the foregoing dipole moment (instrument longitudinal) axis. It will be appreciated by those skilled in the art that different numbers of antennas having dipole moments oriented along other directions may be used to equal effect provided that there are sufficient numbers of such antennas and their respective dipole moment axes enable solution to equations (5) and (6) below.

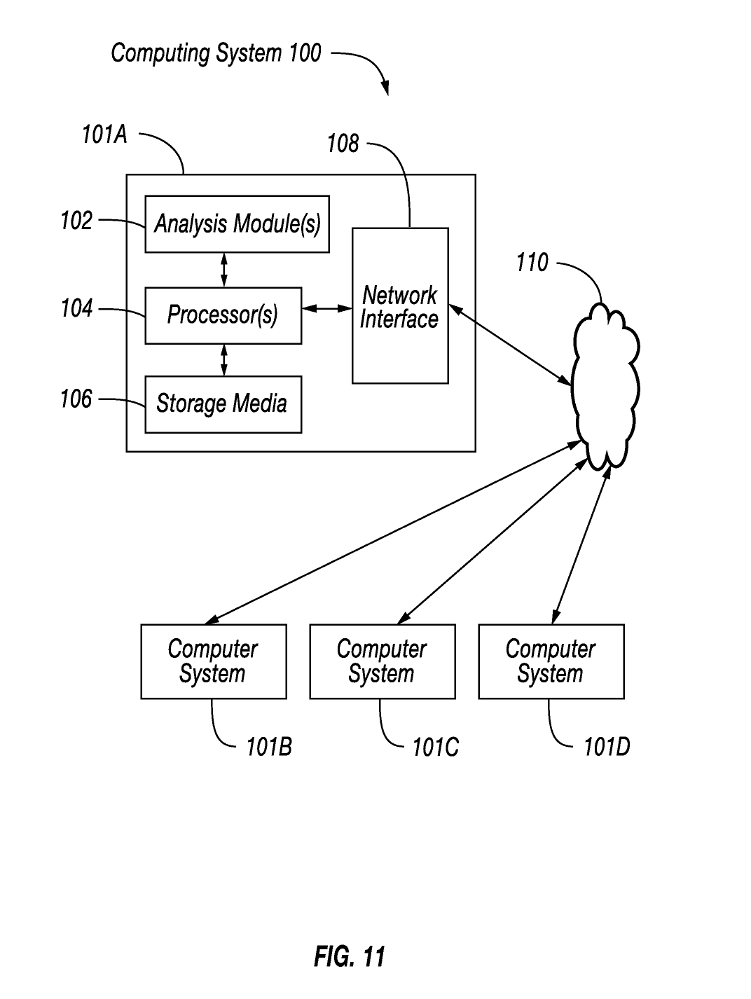

The instrument housing 111 may be coupled to an end of an armored electrical cable 33 that may be extended into and retracted from the wellbore 32. The wellbore 32 may or may not include metal pipe or casing 16 therein. The armored electrical cable 33 may conduct electrical power to operate the instrument 30 from a surface 31 deployed recording system 70, and signals from the receivers 116, 117 may be processed by suitable circuitry 118 in the instrument housing 111 for transmission along the cable 33 to the recording system 70. The recording system 70 may include a computer or computer system as will be explained below with reference to FIG. 11 for analysis of the detected signals as well as devices for recording with respect to depth and/or time the signals communicated along the cable 33 from the instrument 30. Those skilled in the art will recognize that the instrument shown in FIG. 1A may also be configured to be conveyed by a drill string used to drill the wellbore 32, and thus form part of a logging while drilling (“LWD”) instrument or instrument system. Such LWD instruments may include devices therein for recording signals detected by the various sensors (e.g., the multiaxial electromagnetic receivers) and any other detectors in the instrument, and may include a communication subsystem for transmitting some or all of such signals to the recording unit 70 at the surface, for example, by modulating pressure of drilling fluid pumped into the drill string. Instrument conveyance by the cable 33 shown in FIG. 1A is therefore not to be construed as a limit on the scope of the present disclosure.

FIG. 1B shows a non-limiting example wellbore imaging instrument, for example, an instrument as described more fully in U.S. Pat. No. 5,519,668 issued to Montaron and incorporated herein by reference for imaging a wellbore wall while a wellbore is being drilled. One possible embodiment of a drill string 210 includes devices for acquiring and transmitting data for constructing a real-time image of the formation surrounding the borehole. The drill string 210 penetrates the formation 212 as a drill bit 214 rotates in the direction shown by arrow 216. Although it is possible to rotate the drill bit 214 without also rotating the drill string 210, for purposes of the present example, it is the rotation of the drill string 210 which is important. As the drill string 210 rotates, several components located above the bit 214 take measurements regarding the formation 212 around the wellbore 213 and the angular orientation of the drill string 210. In particular, a resistivity sensor 218 may be provided with one or more resistivity buttons 220 which measure the resistivity of the formation 212 at the point where the button 220 faces the wall of the wellbore 213. The resistivity button 220 is coupled to a processor 221 for processing resistivity measurements to obtain an “image” as explained in the Montaron patent.

In addition to the resistivity sensor 218, a position sensor 222 may be provided with a magnetic field sensor (three axis magnetometer) 224 and a gravity sensor (three axis accelerometer) 226, both of which may be coupled to a processor 228. As known in the art, the processor 228 may combine three-dimensional magnetic and gravitational data from the magnetic field sensor 224 and gravity sensor 226 to provide toolface (instrument rotational index) data. As mentioned above, the toolface is the instantaneous angular position of a point (e.g., a slick pin 223) on the surface of the drill string 210 as the drill string 210 rotates. Thus, in one rotation of the drill string, the toolface will change from 0 to 360 degrees and then repeat this scale during the next rotation of the drill string 210. The drill string 210 may also be provided with a mud pulse telemetry unit 230 for transmitting data to a surface processors 240 at the surface for creating images and logs 242. As the drill string 210 rotates, the resistivity button 220 on the resistivity sensor 218 is capable of taking many rapid measurements of the resistivity of the formation 212 around the circumference of the wellbore 213. The resistivity measurements are indicative of the type of formation (mineral and porosity) present around the wellbore, e.g., sand, clay, lignite, montmorillonite, water, bound water, gas, oil, etc., each of which have a different resistivity, typically in the range of 0.2 to 2,000 ohm-meters.

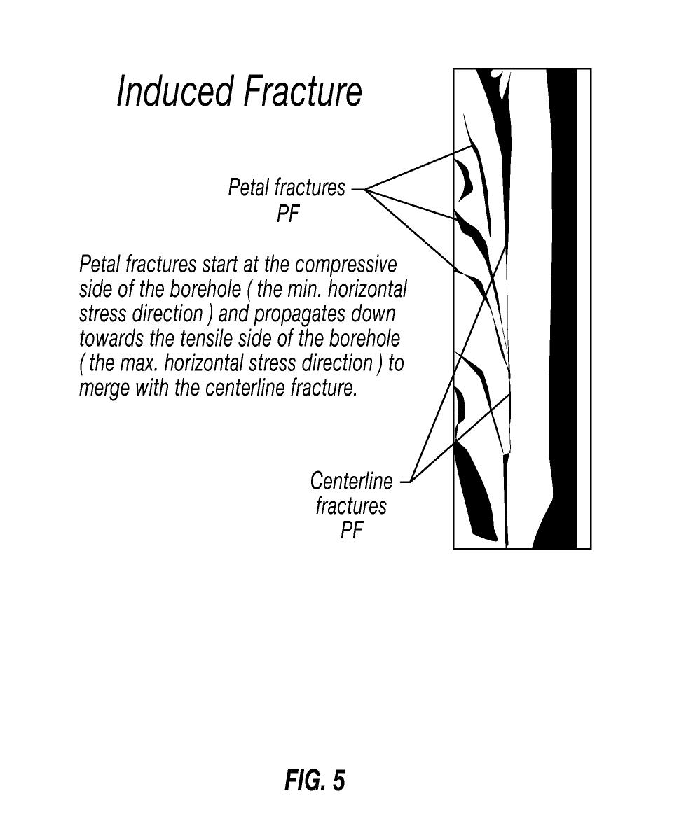

As shown in FIG. 1B, the resistivity sensor 218 may be fixed relative to the position sensor 222 so that both sensors 218, 222 rotate together. The resistivity button 220 may be angularly offset from the slick pin 223 by a known angle [α] so that by determining the toolface angle of the slick pin 223, the toolface (angular orientation) of the resistivity button 220 may also be determined. The depth 232 of the resistivity sensor 218 may be computed at the surface using methods such as those described in U.S. Pat. No. 4,843,875, incorporated herein by reference. As with the example multiaxial induction instrument shown in FIG. 1A, the example imaging instrument shown in FIG. 1B may be conveyed through the wellbore other than on a drill string. For example and without limitation, the imaging instrument may be conveyed by electrical cable (“wireline”). Furthermore, the imaging instrument is not limited to resistivity type. Other imaging devices known in the art, including acoustic, optical, nuclear imaging instruments, may be used in other examples to equal effect. An “imaging” instrument for purposes of this disclosure may be defined as an instrument that makes measurements of a property of formations proximate a wall of a wellbore, circumferentially around the wall of the wellbore, and wherein such measurements are converted into an optical representation of the value of the formation property with respect to circumferential orientation and depth (axial position) within the wellbore. The optical representation may be, for example and without limitation, in the form of gray scale or color indicative of the value of the measured formation property, e.g., resistivity, acoustic reflectance amplitude, etc. Examples of the foregoing image optical presentation will be described with reference to FIGS. 5, 6 and 7.

Having explained generally how to obtain multiaxial induction measurements and wellbore image measurements, example techniques for determining the in situ maximum stress direction from such measurements will now be explained in more detail.

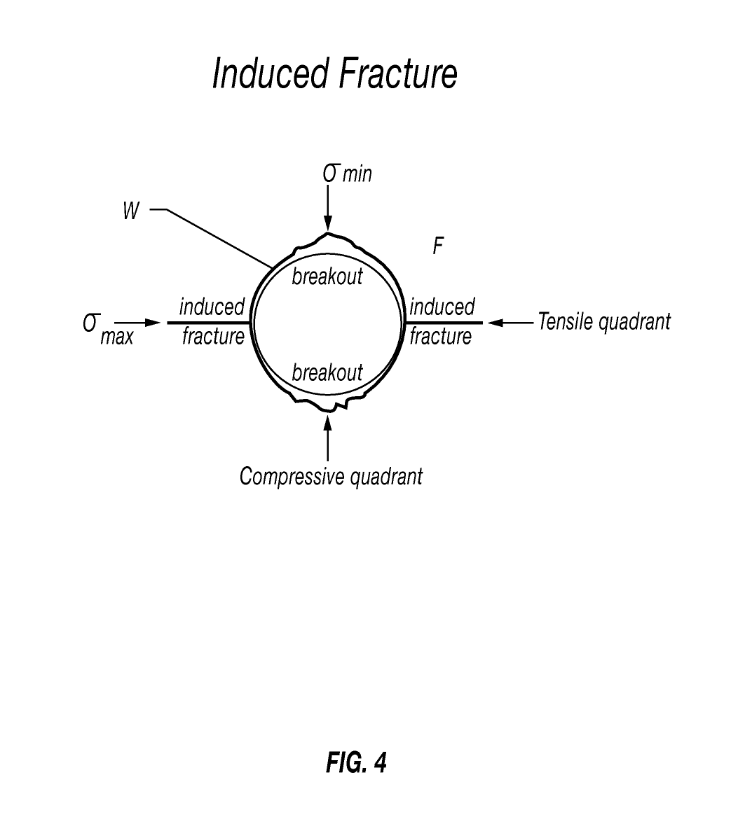

FIG. 4 is a longitudinal end view of a wellbore W showing the maximum and minimum horizontal stress direction, σₘₐₓ and σₘᵢₙ, respectively. Usually, wellbore “breakout” (fracturing of the formation adjacent the wellbore W by fluid pressure therein) occurs along the σₘᵢₙ direction, which is under compression once the wellbore W is drilled. Hydraulic fractures would typically occur if fluid is pumped into the formation for such purpose substantially along the σₘₐₓ direction, which is under tension. The σₘᵢₙ direction is often referred to as the compression quadrant and the σₘₐₓ direction is referred to as the tensile quadrant. Note that the σₘₐₓ and σₘᵢₙ directions illustrated in FIG. 4 are the “near field” stresses created by the wellbore W existing within the subsurface formation F. The foregoing stress directions may not necessarily align with the far field horizontal maximum and minimum stress directions.

The pressure exerted on the formation F from the drill bit (214 in FIG. 1B) often induces fractures. Such induced fractures may be in the form of petal, centerline, and petal-centerline fractures. A whole core sample photograph of such fractures is shown in FIG. 5. Petal fractures PF tend to form just ahead of the drill bit starting at the compressive quadrant and propagate down hole (in a direction ahead of the drill bit) toward the tensile quadrant. Centerline fractures CF propagate ahead of the drill bit (214 in FIG. 1B) with a strike (geodetic azimuth) in the σₘₐₓ direction. Such azimuth may not track the center of the wellbore (W in FIG. 4) unless the least principal stress is perpendicular to the wellbore (W in FIG. 4). The petal fractures PF may or may not grow into the centerline fractures CF. When the foregoing takes place, the result may be referred to as petal-centerline fractures.

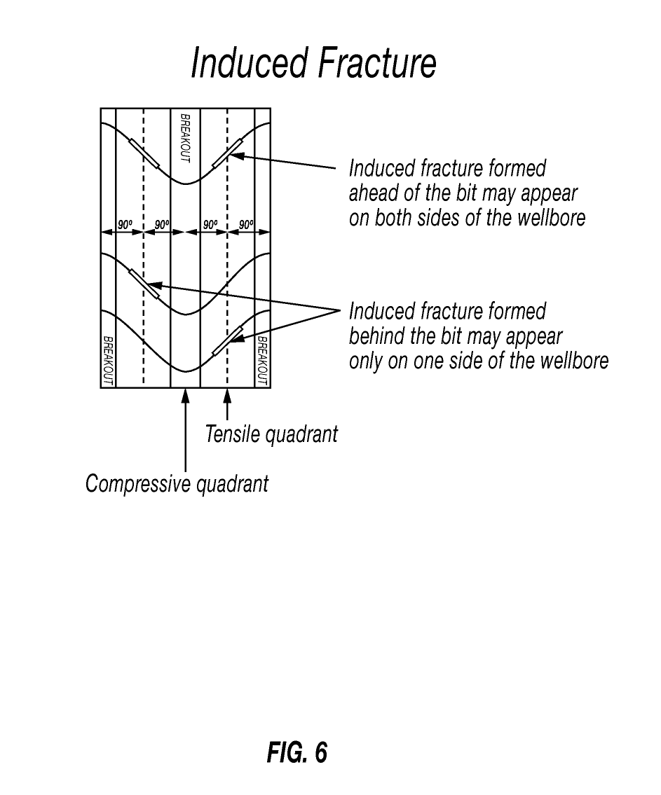

FIG. 6 shows some example patterns of induced fractures. Induced fractures that may be formed ahead of the drill bit (FIG. 2) may appear on both sides of the wellbore, and may be 180 degrees apart as shown in the upper portion of FIG. 6 in the “sine wave” of the wellbore image obtained using, for example, the wellbore imaging instrument explained with reference to FIG. 1B. The induced fractures formed behind the drill bit may appear only on one side of the wellbore as shown in the bottom part of FIG. 6 in the sine wave of the wellbore image. This is because after the wellbore is drilled, the two sides of the borehole may be decoupled by the borehole fluid. Both of these types of fractures are usually disposed in the tensile quadrant (FIG. 4).

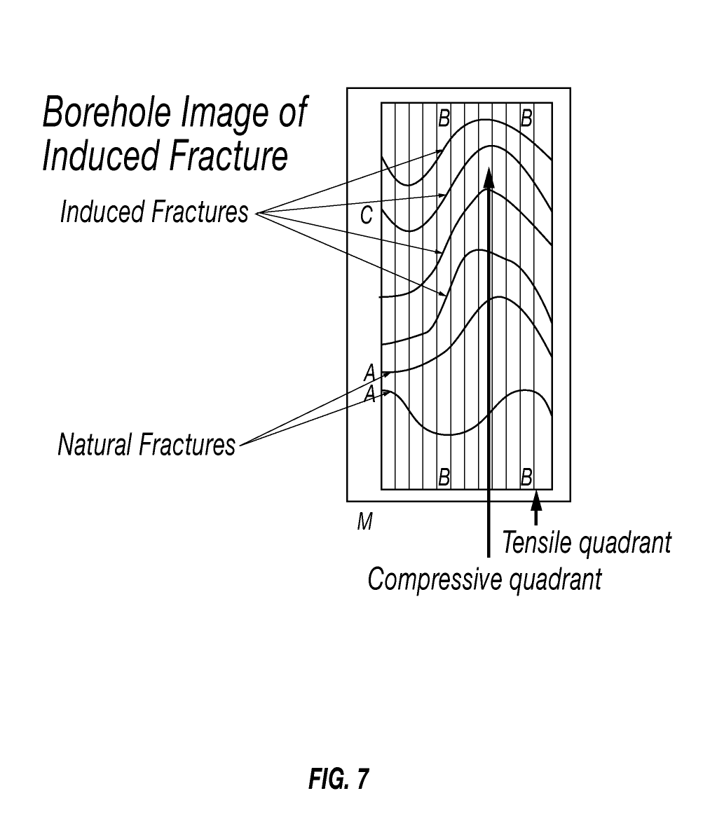

FIG. 7 shows an example of a wellbore image (obtained, e.g., using the instrument explained with reference to FIG. 1B) containing both induced fractures and natural fractures. The two fractures indicated by A near the bottom of FIG. 7 are natural fractures. Natural fractures may be formed by paleo-stresses (stresses existing in prior geologic time) as previously explained, which may be quite different from geologic stresses existing at the time the wellbore is drilled. The example of FIG. 7 shows that these two fractures A, which are planar features completely intersecting the wellbore, may have different dip and azimuth from each other and from those of induced fractures. They could be formed at different times and under different stress fields. Generally, there is no expected consistency between natural fractures unless they are formed by the same tectonic stress over a similar geologic time period. The rest of the fractures shown in FIG. 7 at C are induced fractures, which in the present example were formed during the drilling process, and their orientations are controlled by the present in situ stress field. Therefore, there may be consistency of orientation and stress directions in the far field between the induced fractures. They are shown as arranged in parallel rows on opposite side of the wellbore. The induced fractures C in the present example may be behind-the-bit created hydraulic fractures because they are not symmetrical.

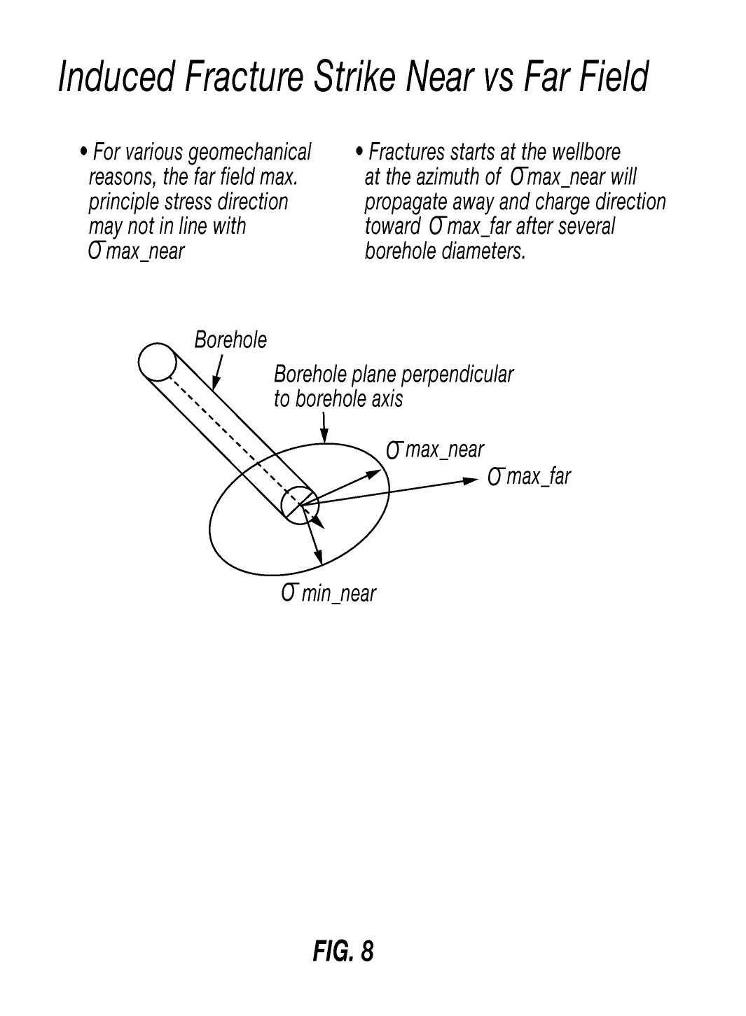

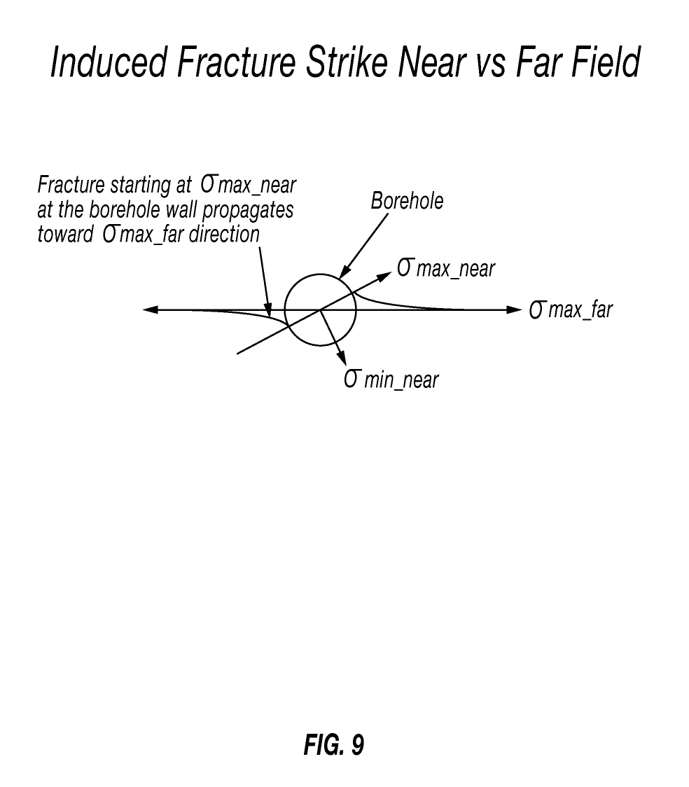

The induced fractures observed on the wellbore wall may correspond to the state of only the near field stress, as previously explained. Drilling dynamics may cause the near field maximum and minimum horizontal stress direction around the wellbore to be quite different from those of the far field maximum and minimum horizontal stress, as explained above. Induced fractures, for example, from pumping fluid into the wellbore, may start on the wellbore wall's tensile quadrant. Such fractures may propagate away from the wellbore and reorient toward the far field maximum horizontal stress direction. This is illustrated schematically in FIGS. 8 and 9. Methods known in the art for measuring fracture orientation using borehole images can only infer the near field stress status from induced fractures. For large fractures associated with hydraulic fracturing for enhanced hydrocarbon production, it is believed that the far field maximum horizontal stress direction would ultimately determine the overall effective induced fracture strike direction.

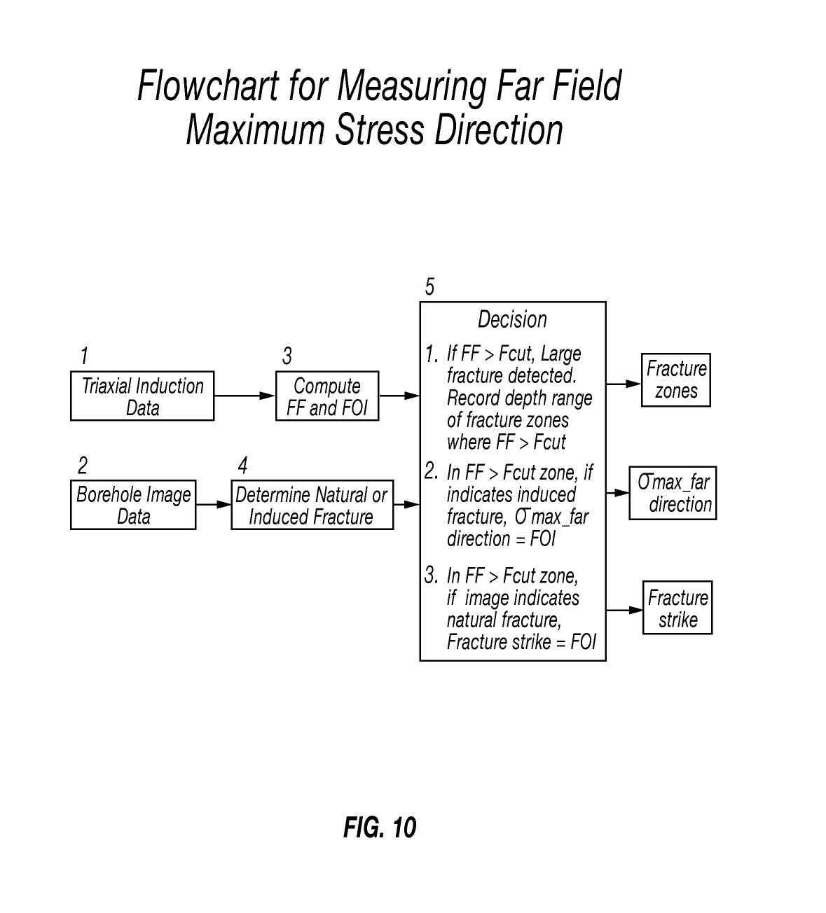

For induced fractures, the measured effective fracture strike is a good indicator of the far field maximum horizontal direction. The present example technique obtains the far field maximum horizontal direction is illustrated in the flow chart in FIG. 10. At 1 and 2 multiaxial induction measurements and wellbore image measurements form inputs to the process. The wellbore image measurements may be obtained using the example instrument explained with reference to FIG. 1B, or any other high resolution imaging instrument that is capable of detecting fractures on the wellbore wall.

At 3 is an algorithm for computing a fracture indicator flag, FF, and the fracture orientation indicator, FOI. The FF maybe presented as a function of well depth with a value proportional to the probability of existence of a large fracture system. Over the zones where FF is larger than a preset threshold or cutoff value, Fcut, the zones are deemed to be fracture zones. Within such fracture zones, the FOI is the computed fracture strike angle. Outside the determined fracture zones, FOI has no meaning. One example of determining the fracture indicator may be implemented as follows. Assume for the sake of simplicity of the explanation that the X-coordinate of the multiaxial induction instrument is pointing toward geodetic north to simplify the determination of the results. The Y-coordinate would then be pointing east and the Z-coordinate would be pointing downward. The multiaxial transmitter and each multiaxial receiver are located on the instrument separated by a distance called the TR spacing. Physical intuition suggests that the most sensitive components in the conductivity tensor to detect the presence and its orientation of the large vertical fractures are the components in the plane perpendicular to the tool axis when the tool axis is oriented nearly vertically under the foregoing conditions. Based on observation of many modeled data of fractured anisotropic formations, it has been determined that in the presence of a large vertical fracture, the far field (i.e., that determined with larger TR spacing, such as TR=72 inches) transverse coupling of the measured tri-axial conductivity tensor will have the following relation with respect to the fracture strike angle θ:

σxx=A+B*cos(2θ) (1)

σyy=A−B*cos(2θ) (2)

σxx₄₅=A−B*sin(2θ) (3)

The spacing for the receiver measurements actually used in any particular instance should be spaced apart from the transmitter such that the lateral depth of investigation of the particular receiver measurements may be expected to be substantially always in the far field. The present example uses a transmitter to receiver spacing of 72 inches. An expected minimum value for transmitter to receiver spacing to obtain similar results may be on the order of several borehole diameters, such as 30 inches for a nominal diameter wellbore of 10 inches, i.e., the transmitter to receiver spacing may be related to the nominal wellbore diameter. In equation (3), σxx₄₅ represents the σxx component of the measured apparent conductivity tensor, σₐ, rotated 45 degrees around the z-axis. The individual components of the conductivity tensor for each multiaxial receiver, as shown in FIG. 2, may be expressed as voltage induced in each individual component receiver antenna (and afterward converted to an apparent conductivity). The rotated conductivity tensor, σₐᵣ, is given by the following expression:

$${σ}_{ar} = R {σ}_{a} {R}^{T} , \\ {σ}_{a} = [ \begin{matrix}{σ}_{xx} {σ}_{yx} {σ}_{zx} \\ {σ}_{xy} {σ}_{yy} {σ}_{zy} \\ {σ}_{xz} {σ}_{yz} {σ}_{zz}\end{matrix} ] , \\ R = [ \begin{matrix}cos ( φ ) & sin ( φ ) & 0 \\ - sin ( φ ) & cos ( φ ) & 0 \\ 0 & 0 & 1\end{matrix} ] \qquad ( 4 )$$

R is the rotation matrix and the rotation angle Φ=45 degrees.

In equations (1)-(3), A and B are functions of the fracture parameters (FD, FW, FH) and the wellbore/formation parameters (Rh, Rv, Dip, decc, azf, azt).

A(FD, FW, FH, Rh, Rv, Dip, decc, azf, azt)

B(FD, FW, FH, Rh, Rv, Dip, decc, azf, azt)

The following are the notation for various parameters above:

FD—fracture displacement

FW—fracture width

FH—fracture height

Rh—formation horizontal resistivity

Rv—formation vertical resistivity

Dip—the dip angle of the anisotropy

azf—the dip azimuth angle of the anisotropy

decc—tool eccentering distance

azt—the tool eccentering orientation angle

From equations (1)-(3), it is possible to solve for B and the fracture strike angle 0 as follows:

θ=0.5*tan⁻¹[(σxx+σyy−2*σxx₄₅)/((σxx−σyy)] (5)

B=0.5*(σxx−σyy)/[δ+cos(2θ)] (6)

The δ in equation (6) is a very small constant which may be used for the purpose of preventing the denominator therein from being zero.

Simulation of the results suggest the value of B is a strong function of FR, RH, Rh, and Dip. The B value for formations with large vertical fractures is much larger than that for the same formation without large fractures. The magnitude of B can therefore be used to indicate the existence of large vertical fractures. Referring still to FIG. 10, after determining the existence of fracture zones, as explained above, at 4 it is determined whether the fractures are natural fractures or induced fractures based on the borehole image pattern. There are many selection criteria which may be used to determine whether a fracture is natural or induced. The following are a few non-limiting examples. Determining whether the fractures are naturally occurring or induced may include determining whether one or more of the following conditions exists:
the fractures stack together over depth and appear over the same azimuth of the wellbore;
the fractures do not completely intersect the wellbore;
the fractures appear in the tensile quadrants of the wellbore; and
the fractures are asymmetrically developed.

Responding to similar in situ stress over zone of similar lithology and tectonic stress, induced fractures tend to stack together over depth and appear over the same azimuth of the borehole. Induced fractures often do not completely intersect the wellbore while natural fracture often intersect through the entire wellbore wall to form a well-developed sine wave pattern in the wellbore image data. Induced fractures appear in the tensile quadrants of the wellbore, which are 90 degree from the breakouts (compressive quadrants of the borehole). Behind-the-bit induced fractures are often asymmetrically developed. As can be appreciated by those skilled in the art, the above list of criteria is not exhaustive. There are other indicators of induced fractures that will occur to those skilled in the art.

Still referring to FIG. 10, at 5 is decision logic to determine whether in a given fracture zone, the FOI can be used to infer the direction of the far field maximum horizontal stress direction. At (1) in decision logic 5, fracture zones may be identified where FF>Fcut, as defined above. At (2) in decision logic 5, if the fracture is determined to be natural, the FOI (computed as explained above) may indicate the fracture strike. The status of in situ stress cannot be inferred from FOI in a zone with natural fractures. If the fracture is induced, however, as shown at (3) in decision logic 5, the FOI can be interpreted as the far field maximum horizontal stress direction.

Another embodiment of a technique according to the present disclosure to enhance the robustness of estimation of the far field in situ maximum horizontal stress direction is to deliberately create induced fractures over a zone of interest by increasing the mud weight (drilling fluid density) or other drilling practices such as increasing the axial force (weight) on the drill bit during drilling. Ordinarily, care is taken to ensure that the mud weight and weight on bit are properly balanced such that the formation is not fractured or damaged. However, under certain conditions, such as shale gas “pay” (commercially productive) zones, the benefit of having a reliable estimation of the far field in situ maximum horizontal stress direction may outweigh the risk of damaging the formation.

The method described above can be applied to an efficient shale gas production technique. Shale gas production depends to a great extent on hydraulic (i.e., induced) fracturing. The in situ far field maximum horizontal stress direction can help predict along which direction hydraulic fractures will propagate. Over a gas shale “pay” zone, a grid of pilot wells can be drilled and logged with the multiaxial (e.g., triaxial) electromagnetic induction tool and the borehole imaging tool, as explained with reference to FIGS. 1A and 1B, respectively. To ensure large hydraulic fractures exist over the zone of interest, preferably higher mud weight may be used for those pilot wells over the target shale gas zones. In this way, the fracture strike measured by the above described method may be used to infer the in situ far field maximum horizontal stress direction. A far field maximum horizontal stress direction map can then be obtained from the data of the grid of pilot wells covering the gas shale pay area. Based on this map, efficient production well paths can be designed, e.g., paths oriented substantially perpendicular to the far field maximum stress direction. In this way, the hydraulic fractures induced in “production” wells (wellbores used to withdraw fluids from one or more subsurface formations) may have the maximum later penetration into the formation away from the wellbore and a fracture path with the least possible tortuosity.

FIG. 11 shows an example computing system 100 in accordance with some embodiments for carrying out example methods such as those explained above. The computing system 100 can be an individual computer system 101A or an arrangement of distributed computer systems. The computer system 101A includes one or more analysis modules 102 that are configured to perform various tasks according to some embodiments, such as the tasks depicted in FIG. 10. To perform these various tasks, an analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, in a well logging unit disposed proximate a wellbore drilling, while in communication with one or more computer systems such as 101C and/or 101D that are located in one or more data centers on shore, other ships, and/or located in varying countries on different continents).

A processor can include a microprocessor, microcontroller, processor module or subsystem, programmable integrated circuit, programmable gate array, or another control or computing device. As used herein, the term “computer” or “computer system” or the like should be understood to refer to any suitable computing device having a processor and which is adapted to perform one or more of the methods disclosed herein. For instance, a computer may include handheld computing devices or mobile device (e.g., smart phones, tablets, etc.).

The storage media 106 can be implemented as one or more non-transitory computer-readable or machine-readable storage media. Note that while in the embodiment of FIG. 11 the storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the embodiment of FIG. 2, and/or computing system 100 may have a different configuration or arrangement of the components depicted in FIG. 2 and FIG. 11. The various components shown in FIG. 11 may be implemented in hardware, software, or a combination of both hardware and software, including one or more signal processing and/or application specific integrated circuits.

Further, the steps in the methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining far field maximum stress direction of formations penetrated by a wellbore from multiaxial electromagnetic induction measurements and formation image measurements made in the wellbore, comprising:
determining in a computer whether fractures exist in a far field from the wellbore using the multiaxial electromagnetic induction measurements;
determining in the computer whether the fractures are naturally occurring or induced using the formation image measurements;
determining in the computer an orientation of the fractures when the fractures are determined to be induced from the multiaxial electromagnetic induction measurements; and
determining in the computer the far field maximum horizontal stress direction from the determined orientation.

2. The method of claim 1 wherein the determining whether the fractures are naturally occurring or induced comprises determining in the computer if at least one of the following conditions exists:
the fractures stack together over depth and appear over the same azimuth of the wellbore;
the fractures do not completely intersect the wellbore;
the fractures appear in the tensile quadrants of the wellbore; or
the fractures are asymmetrically developed.

3. The method of claim 1 further comprising:
inducing fractures in at least one selected subsurface formation in a plurality of wellbores drilled therethrough;
in a computer, mapping over a selected area a far field maximum horizontal stress direction based on a determined far field maximum horizontal stress direction in each wellbore; and
in a computer, generating a wellbore trajectory that is substantially perpendicular to the determined far field maximum horizontal stress direction over the mapped area over substantially the entire wellbore trajectory.

4. The method of claim 3 wherein the generated wellbore trajectory is oriented substantially perpendicular to the far field maximum horizontal stress direction.

5. The method of claim 1 wherein the formation image measurements comprise resistivity measurements proximate a wall of the wellbore.

6. The method of claim 1 wherein the multiaxial electromagnetic induction measurements comprise measurements of voltages induced in each coil of each of a plurality of triaxial receiver coils each disposed at a different distance from at least one triaxial electromagnetic transmitter coil.

7. The method of claim 6 wherein the at least one triaxial electromagnetic transmitter coil is energized by at least one of a discrete frequency continuous wave electric current and a transient electric current.

8. The method of claim 1 wherein the determining orientation of the fractures uses multiaxial electromagnetic induction measurements made at a distance from an electromagnetic transmitter such that a lateral depth of investigation of the multiaxial electromagnetic induction measurements is substantially always disposed in a far field stress regime.

9. A method for well logging, comprising:
moving a multiaxial electromagnetic induction well logging instrument and a wellbore imaging well logging instrument along an interior of a wellbore;
measuring a multiaxial electromagnetic induction response of formations adjacent the wellbore;
measuring a parameter related to a formation property proximate a wall of the wellbore using the wellbore imaging well logging instrument;
determining a far field maximum horizontal stress direction of formations penetrated by the wellbore from the multiaxial electromagnetic induction measurements and formation parameter measurements, wherein the determining the far field maximum stress direction of the formations comprises, determining in a computer whether fractures exist in a far field from the wellbore using the multiaxial electromagnetic induction measurements, determining in the computer whether the fractures are naturally occurring or induced using the formation image measurements, determining in the computer an orientation of the fractures when the fractures are determined to be induced from the multiaxial electromagnetic induction measurements, and determining in the computer the far field maximum stress direction from the determined orientation.

10. The method of claim 9 wherein the determining whether the fractures are naturally occurring or induced comprises determining in the computer if at least one of the following conditions exists:
the fractures stack together over depth and appear over the same azimuth of the wellbore;
the fractures do not completely intersect the wellbore;
the fractures appear in the tensile quadrants of the wellbore; or
the fractures are asymmetrically developed.

11. The method of claim 9 further comprising:
inducing fractures in at least one selected subsurface formation in a plurality of wellbores drilled therethrough;
in a computer, mapping over a selected area a far field horizontal stress direction based on determined far field maximum horizontal stress direction in each wellbore; and in a computer, generating a wellbore trajectory that is substantially perpendicular to the far field maximum horizontal stress direction over the mapped area over substantially the entire wellbore trajectory.

12. The method of claim 11 wherein the generated wellbore trajectory is oriented substantially perpendicularly to the determined far field maximum horizontal stress direction.

13. The method of claim 9 wherein the formation image measurements comprise resistivity measurements proximate the wall of the wellbore.

14. The method of claim 9 wherein the multiaxial electromagnetic induction measurements comprise measurements of voltages induced in each coil of each of a plurality of triaxial receiver coils each disposed at a different distance from at least one triaxial electromagnetic transmitter coil.

15. The method of claim 14 wherein the at least one triaxial electromagnetic transmitter coil is energized by at least one of a discrete frequency continuous wave electric current and a transient electric current.

16. The method of claim 9 wherein the determining orientation of the fractures uses multiaxial electromagnetic induction measurements made at a distance from an electromagnetic transmitter such that a lateral depth of investigation of the multiaxial electromagnetic induction measurements is substantially always disposed in a far field stress regime.

17. The method of claim 9 wherein moving at least one of the multiaxial electromagnetic induction well logging instrument and the moving the wellbore imaging instrument comprises extending and/or retracting an electrical cable through the wellbore.

18. The method of claim 9 wherein moving at least one of the multiaxial electromagnetic induction well logging instrument and the moving the wellbore imaging instrument comprises moving a drill string through the wellbore.

19. A system comprising:
a multiaxial electromagnetic induction well logging instrument;
an imaging well logging instrument;
a computer comprising a memory device storing instructions and a processor configured to execute the stored instructions to cause the computer to:
acquire a measurement of a multiaxial electromagnetic induction response of formations adjacent the wellbore as the multiaxial electromagnetic induction well logging instrument is moved along the wellbore;
acquire a measurement of a parameter related to a formation property proximate a wall of the wellbore as the wellbore imaging well logging instrument is moved along the wellbore; and
determine a far field maximum horizontal stress direction of formations penetrated by the wellbore from the multiaxial electromagnetic induction measurement and formation parameter measurement, wherein the determination of the far field maximum stress direction of the formations comprises, determining whether fractures exist in a far field from the wellbore using the multiaxial electromagnetic induction measurement, determining whether the fractures are naturally occurring or induced using the formation image measurement, determining an orientation of the fractures when the fractures are determined to be induced from the multiaxial electromagnetic induction measurement, and determining the far field maximum stress direction from the determined orientation.

20. The system of claim 19, wherein the formation image measurement comprise a resistivity measurement proximate the wall of the wellbore.
